(19) United States
(12) Patent Application Publication
(10) Pub. No.: US 2001/0016632 A1
(43) Pub. Date: Aug. 23, 2001

(54) Heavy duty packaging film

(75) Inventor: Peter Sipos, Calgary (CA)

Correspondence Address: Kenneth H. Johnson, P.O. Box 630708, Houston, TX, 77263, US

(73) Assignee: NOVA CHEMICALS (INTERNATIONAL) S.A.

(21) Appl. No.: 09/804,574

(22) Filed: Mar. 12, 2001

Related U.S. Application Data
(63) Continuation of application No. 09/610,518, filed on Jul. 6, 2000.

(30) Foreign Application Priority Data
Jul. 9, 1999 (CA) 2,277,259

(51) Int. Cl. C08F 10/02; C08F 210/02

(52) U.S. Cl. 526/65; 526/348.1; 526/348.2

(57) ABSTRACT

Polyethylene film having a combination of a high melt strength and a high dart impact strength is prepared from a linear low density polyethylene resin having a melt index, (“I₂”), of from 0.4 to 1.5 g/10 minutes, a broad molecular weight distribution (of from 3.5 to 7) and a quasi homogeneous comonomer distribution (as evidenced by a copolymer/homopolymer ratio of from 3 to 19). The polyethylene resin is prepared in a dual reactor polymerization process. The film is especially useful for industrial and “heavy duty” packaging applications such as the manufacture of plastic packages used to contain goods for the construction, gardening and agricultural businesses. Examples of such goods include peat moss, fertilizer, soil, sand, salt, fiberglass insulation and crushed stone. The film has improved strength properties which are typically associated with those made from homogeneous (or “metallocene”) polyethylene resins, yet also retains a stiff plastic “feel” which is not present in many metallocene resins. Most importantly, the plastic film of this invention may be produced at very high line speeds (i.e. improved production rates/efficiencies) in comparison to films made from prior art resins.

### FIELD OF THE INVENTION

This invention relates to plastic films made from linear low density polyethylene.

### BACKGROUND OF THE INVENTION

Plastic film is a ubiquitous item of commerce. A large portion of this film is prepared from linear low density polyethylene which is a copolymer of ethylene with a minor amount of an alpha olefin such as butene, hexene or octene.

Linear low density polyethylene (lldpe) is conventionally prepared by a polymerization process using a so-called Ziegler-Natta (“Z/N”) catalyst. It is well known to those skilled in the art that the conventional lldpe resins prepared with Z/N catalysts do not have a uniform structure or composition. In particular, these conventional resins typically contain a minor amount of a very low density copolymer; a major portion of the “copolymer” having the desired molecular weight and density; and a large “homopolymer” fraction (which does not contain a meaningful amount of the desired comonomer). This lack of polymer homogeneity is associated with several disadvantages (for example, organoleptic issues caused by the low molecular weight material and sub optimal impact strengths which are believed to be caused by the crystallinity of the homopolymer fraction). The development of “homogeneous polyethylene” resins has mitigated these disadvantages.

Homogeneous resins may be prepared with the so-called metallocene catalysts which are well known and widely described in the literature.

The resulting “homogeneous” resins have a very uniform composition as evidenced by the substantial absence of very low molecular weight/low density fractions and/or homopolymer fractions. These homogeneous resins exhibit excellent organoleptic properties and impact strength properties but can be deficient in tear properties. Moreover, these resins are difficult to “process” (or convert) into plastic film. In addition, the resulting plastic films have a distinctive soft “touch” or “feel” in comparison to the “crinkly” or “plastic” feel of films made from conventional lldpe. Some consumers dislike this difference. In addition, the softness/limpness of these metallocene films can produce a more quantifiable disadvantage such as when it is desirable for the film to have sufficient stiffness to exhibit a “self supporting” characteristic.

The present invention provides a plastic film which mitigates certain of the disadvantages of films made from either “conventional” and “homogeneous” polyethylene resins. Most importantly, the film of this invention may be produced at very high production rates, thus improving efficiencies and lowering costs.

### SUMMARY OF THE INVENTION

The present invention provides polyethylene film having a melt strength of greater than 0.20 grams per three minutes and a dart impact strength of greater that 200 grams per mil as determined by ASTM D1708-85, wherein said polyethylene film is prepared from a linear low density polyethylene is characterized by having:

1) a melt index, 12, as determined by ASTM of from 0.4 to 1.5;

2) a polydispersity, Mw/Mn, of from 3.5 to 7;

3) a copolymer/homopolymer ratio of from 3 to 19; and

4) a density of from 0.915 to 0.930 grams per cubic centimeter;

and wherein said polyethylene resin is further characterized by being prepared in a dual reactor polymerization process.

The film of this invention is prepared with a polyethylene resin which must have a comparatively low density and low melt index. However, the film has excellent melt strength and, as a result, is readily manufactured by a blown film process. While not wishing to be bound by any theory, it is believed that the excellent processability of the films of this invention are attributable to two essential characteristics of the lldpe used to make them, namely a combination of a) a comparatively broad molecular weight distribution and b) the presence of a quasi homogeneous comonomer distribution (as evidenced by the copolymer/homopolymer ratio).

Furthermore, the lldpe resins of this invention must also have a very low melt index and a comparatively low density. While not wishing to be bound by any particular theory, it is believed that this combination of very low melt index and comparatively low density contribute to the high strength of films prepared from the resins.

The lldpe resins used in this invention are further characterized by having a medium-to-broad molecular weight distribution. The resins are prepared in a dual reactor process (as will be described in the examples) and the molecular weight distribution reflects this with a bimodal character. While not again wishing to be bound by theory, it is believed that the combination of a) the broad molecular weight distribution; and b) the small amount of homopolymer polyethylene are both required in order to provide the desired “processability” and physical properties.

It is believed that the “quasi homogeneous” lldpe resins of the type described above have not been heretofore commercially available. We have discovered that plastic film made from these resins has a very surprising and highly desirable balance of processability and strength properties. These plastic films are particularly well suited for heavy duty packaging applications, such as packages for fiberglass insulation or packages for dense granular goods such as fertilizer, industrial salt or crushed stone.

The lldpe used in this invention is preferably prepared using a Z/N catalyst system in a dual reactor solution polymerization process which is characterized by having excellent agitation in the polymerization reactors, as discussed in the Detailed Description and Examples.

### DETAILED DESCRIPTION

The lldpe resins used in this invention have a low melt index (I₂), a medium-to-broad molecular weight distribution and a quasi homogeneous comonomer distribution. All of the tests used to quantify these physical characteristics of the resins are well known to those skilled in the art and are described in further detail later in the specification.

The present invention provides a “processability” advantage in comparison to films made from homogeneous resins. Processability may be quantified by two simple tests, namely:

1) the amount of power required to extrude a given mass of polymer (which may be expressed, for example, in watts of electricity per pound of resin); and

2) maximum production rate or “line rate” (which may be expressed, for example, in pounds of product produced per hour).

It is well known that homogeneous resins may be used to produce plastic film having excellent strength properties. However, it is also known that homogeneous resins are difficult to “process” (as described by results from both of the above tests—i.e. 1) it typically requires large amounts of power to extrude homogeneous resins; and 2) many homogeneous resins have a comparatively poor bubble stability which forces reduced “line speeds”).

It has been postulated that the use of a broad molecular weight distribution (“MWD”), homogeneous resin may reduce the amount of power required to process a given amount of resin. However, the use of a broad MWD, homogeneous resin does not always mitigate “production rate” problems especially for a blown film process where “bubble instability” is often still observed.

The present invention provides a surprising combination of processability and strength properties. Most surprisingly, the present invention also provides certain processability advantages in comparison to conventional (“heterogeneous”) resins which are in wide commercial use, as will be illustrated in the Examples.

The lldpe resins of this invention are prepared in a polymerization process which employs at least two polymerization reactors (“dual reactor process”). Most preferably, the dual reactor process is further characterized as being a solution polymerization process which uses a Ziegler Natta polymerization catalyst. It is further preferred that the polymerization reactors are very well agitated. Each of these preferred features is described in further detail below.

A.3. Description of Ziegler Natta Catalyst

The term “Ziegler Natta catalyst” is well known to those skilled in the art and is used herein to convey its conventional meaning. A Ziegler Natta catalyst may be used in this invention. Ziegler Natta catalysts comprise at least one transition metal compound of a transition metal selected from groups 3, 4, or 5 of the Periodic Table (using IUPAC nomenclature) and an organoaluminum component which is defined by the formula:

Al(X′)ₐ(OR)_{b}(R)_{c}

wherein: X′ is a halide (preferably chlorine); OR is an alkoxy or aryloxy group; R is a hydrocarbyl (preferably an alkyl having from 1 to 10 carbon atoms); and a, b or c are each 0, 1, 2 or 3 with the provisos text a+b+c=3 and b+c≧1.

It is highly preferred that the transition metal compounds contain at least one of titanium or vanadium. Exemplary titanium compounds include titanium halides (especially titanium chlorides, of which TiCl₄ is preferred); titanium alkyls; titanium alkoxides (which may be prepared by reacting a titanium alkyl with an alcohol) and “mixed ligand” compounds (i.e. compounds which contain more than one of the above described halide, alkyl and alkoxide ligands). Exemplary vanadium compounds may also contain halide, alkyl or alkoxide ligands. In addition vanadium oxy trichloride (“VOCl₃”) is known as a Ziegler Natta catalyst component and is suitable for use in the present invention.

It is especially preferred that the Ziegler Natta catalyst contain both of a titanium and a vanadium compound. The Ti/V mole ratios may be from 10/90 to 90/10, with mole ratios between 50/50 and 20/80 being particularly preferred.

The above defined organoaluminum compound is an essential component of the Ziegler Natta catalyst. The mole ratio of aluminum to transition metal {for example, aluminum/(titanium+vanadium)} is preferably from 1/1 to 100/1, especially from 1.2/1 to 15/1.

As will be appreciated by those skilled in the art of ethylene polymerization, conventional Ziegler Natta catalysts may also incorporate additional components such as an electron donor—for example an amine; or a magnesium compound—for example a magnesium alkyl such as butyl ethyl magnesium and a halide source (which is typically a chloride such as tertiary butyl chloride).

Such components, if employed, may be added to the other catalyst components prior to introduction to the reactor or may be directly added to the reactor.

The Ziegler Natta catalyst may also be “tempered” (i.e. heat treated) prior to being introduced to the reactor (again, using techniques which are well known to those skilled in the art and published in the literature). Particularly preferred Ziegler Natta catalysts and methods of preparing them are described in U.S. Pat. (USP) Nos. 5,492,876; 5,519,098; and 5,589,555.

Part B Description of Dual Reactor Solution Polymerization Process

Solution processes for the copolymerization of ethylene and an alpha olefin having from 3 to 12 carbon atoms are well known in the art. These processes are conducted in the presence of an inert hydrocarbon solvent typically a C₅₋₁₂ hydrocarbon which may be unsubstituted or substituted by a C₁₋₄ alkyl group, such as pentane, methyl pentane, hexane, heptane, octane, cyclohexane, methylcyclohexane and hydrogenated naphtha. An example of a suitable solvent which is commercially available is “Isopar E” (C₈₋₁₂ aliphatic solvent, Exxon Chemical Co.).

The solution polymerization process of this invention must use at least two polymerization reactors. The polymer solution resulting from the first reactor is preferably transferred to the second polymerization (i.e. the reactors are most preferably arranged “in series” so that polymerization in the second reactor occurs in the presence of the polymer solution from the first reactor).

The polymerization temperature in the first reactor is from about 80° C. to about 180° C. (preferably from about 120° C. to 160° C.) and the hot reactor is preferably operated at a slightly higher temperature. Cold feed (i.e. chilled solvent and/or monomer) may be added to both reactors or to the first reactor only. The polymerization enthalpy heats the reactor. The polymerization solution which exits the reactor may be more than 100° C. hotter than the reactor feed temperature. Both reactors must be “stirred reactors” (i.e. the reactors are extremely well mixed with a good agitation system). Agitation efficiency may be determined by measuring the reactor temperature at several different points. The largest temperature difference (i.e. between the hottest and coldest temperature measurements) is described as the internal temperature gradient for the polymerization reactor. A very well mixed polymerization reactor has a maximum internal temperature gradient of less than 10° C. A particularly preferred agitator system is described in copending and commonly assigned U.S. patent application Ser. No. 09/048,945 (now U.S. Pat. No. 6,024,483). Preferred pressures are from about 500 psi to 8,000 psi. The most preferred reaction process is a “medium pressure process”, meaning that the pressure in each reactor is preferably less than about 6,000 psi (about 42,000 kiloPascals or kPa), most preferably from about 1,500 psi to 3,000 psi (about 14,000-22,000 kPa)

Suitable monomers for copolymerization with ethylene include C₃₋₁₂ alpha olefins which are unsubstituted or substituted by up to two C₁₋₆ alkyl radicals. Illustrative non-limiting examples of such alpha-olefins are one or more of propylene, 1-butene, 1-pentene, 1-hexene, 1-octene and 1-decene. Octene-1 is highly preferred.

The monomers are dissolved/dispersed in the solvent either prior to being fed to the first reactor (or for gaseous monomers the monomer may be fed to the reactor so that it will dissolve in the reaction mixture). Prior to mixing, the solvent and monomers are generally purified to remove potential catalyst poisons such as water, oxygen or metal impurities. The feedstock purification follows standard practices in the art, e.g. molecular sieves, alumina beds and oxygen removal catalysts are used for the purification of monomers. The solvent itself as well (e.g. methyl pentane, cyclohexane, hexane or toluene) is preferably treated in a similar manner.

The feedstock may be heated or cooled prior to feeding to the first reactor. Additional monomers and solvent may be added to the second reactor, and it may be heated or cooled.

Generally, the catalyst components may be premixed in the solvent for the reaction or fed as separate streams to each reactor. In some instances premixing it may be desirable to provide a reaction time for the catalyst components prior to entering the reaction. Such an “in line mixing” technique is described the patent literature (most notably U.S. Pat. No. 5,589,555, issued Dec. 31, 1996 to DuPont Canada Inc.).

The residence time in each reactor will depend on the design and the capacity of the reactor. Generally the reactors should be operated under conditions to achieve a thorough mixing of the reactants. In addition, it is preferred that from 20 to 60 weight % of the final polymer is polymerized in the first reactor, with the balance being polymerized in the second reactor. As previously noted, the polymerization reactors are preferably arranged in series (i.e. with the solution from the first reactor being transferred to the second reactor). In a highly preferred embodiment, the first polymerization reactor has a smaller volume than the second polymerization reactor. On leaving the reactor system the solvent is removed and the resulting polymer is finished in a conventional manner.

Further details of the invention are illustrated in the following, non limiting, examples. The examples are divided into two parts.

The first part illustrates the copolymerization of ethylene and octene-1 in a dual polymerization reactor system using a Ziegler Natta catalyst.

The second part illustrates the preparation of the inventive films.

Test Procedures Used In The Examples Are Briefly Described Below

1. Melt Index: “I₂”, “I₆”, “I₂₁” and Melt Flow Ratio (which is calculated by dividing I₂₁ by I₂) were determined according to ASTM D1238. [Note: I₂ measurements are made with a 2.16 kg weight and I₂₁ measurements are made with a 21.6 kg weight.] Test results are reported in units of grams/10 minutes (though these units are often omitted by convention).

2. Stress exponent (“S.Eₓ”) is calculated by log(I₆/I₂)/log(3).

3. Number average molecular weight (Mn); weight average molecular weight (Mw) and polydispersity (calculated by Mw/Mn) were determined by Gel Permeation Chromatography “GPC”).

4. Flexural Secant Modulus and Flexural Tangent Modulus were determined according to ASTM D882.

5. Elongation and Yield measurements were determined according to ASTM D636.

6. Hexane Extractables were determined according to ASTM D5227.

7. Melt strength is determined using the same “melt indexer” apparatus used in the aforementioned ASTM 1238 test method. The apparatus is loaded with resin and preheated for 6 minutes to 1900±0.2° C. as per ASTM D1238. The total piston load used is 18,400 g (consisting of the piston weight of 100 g and a 18,300 g weight). The polymer is allowed to extrude from the melt indexer die until the piston is at a point with 2 cm from its end point. The extrudate thread is then quickly removed and a timing device (e.g. a stopwatch is activated). The timer is stopped when the extrudate thread falls from the die. The amount of extrudate is then weighed. This procedure is repeated at least 5 times at different distances between 2 cm and 0 cm from the piston travel end point, yielding different extrudate weights and corresponding times. The results are plotted on 2×2 log-log graph paper (weight of extrudate in grams versus time in minutes). The “melt strength” is reported as the value (in grams) at the three minute time as is expressed, for example as 0.15 g/ 3 min.

8. Tensile measurements were made according to ASTM D-638-89.

9. Tear measurements were made according to ASTM D9922.

10. Density was determined using the displacement method according to ASTM D792.

11. Copolymer/homopolymer determinations were made using the Temperature Rising Elution Fractionation or “TREF” technique which is well known to those skilled in the art and widely described in the literature. As will be understood by those skilled in the art, the “copolymer” and “homopolymer” fractions of the resin have substantially different melting points. This allows the copolymer and homopolymer fractions to be separated by the Temperature Rising Elution Fractionation (or TREF) technique. The results from this analysis are conventionally expressed as a copolymer/homopolymer (or “COHO”) ratio. A COHO ratio of 4 indicates that the resin has four parts by weight of copolymer per part by weight homopolymer (or 80% copolymer). Likewise, a COHO ratio of 19 corresponds to 95% copolymer.

### EXAMPLES

Part 1

This example illustrates the continuous flow, solution copolymerization of ethylene at a medium pressure using a two reactor system using a Ziegler Natta catalyst. Both reactors are continuously stirred tank reactors (“CSTR'S”). The first reactor operates at a relatively low temperature. The contents from the first reactor flow into the second reactor. The first reactor had a volume of 12 liters. Monomers, solvent and catalyst were fed into the reactor as indicated in Table 1. The solvent used in these experiments was methyl pentane. The contents of the first reactor were discharged through an exit port into a second reactor having a volume of 24 liters. A Ziegler Natta catalyst was used in all experiment catalyst components consisting of titanium tetrachloride (TiCl₄), butyl ethyl magnesium (BEM) and tertiary butyl chloride (TBC), with an aluminum activator consisting of triethyl aluminum (TEAL) and diethyl aluminum ethoxide (DEAO). The BEM and TEAL were provided “premixed” (5/1 Mg/Ti mole ratio).

All catalyst components were mixed in the methyl pentane solvent. The mixing order was BEM/TEAL and TBC; followed by TiCl₄; followed by DEAO. The catalyst was pumped into the reactor together with the methyl pentane solvent. The catalyst flow rate had an aim point as shown in the table and was adjusted to maintain total ethylene conversions above 80%. Ethylene conversions in each reactor are shown in Table 1 as “Q”. For example, QR1 of 94% means that 94% of the ethylene was polymerized.

The steady state flow rate of solvent and monomer to reactor 1 (“R1 ”) and reactor 2 (“R2”) are shown in Table 1. By way of illustration, the total flow of monomer and solvent to R1 for product 1 was 360 kg/hr (consisting of 32 kg/hr ethylene; 21 kg/hr octene; and by difference 307 kg/hr of solvent). Similarly, the fresh feed of monomer and solvent to R2 for product 1 was a total of 380 kg/hr containing 72 kg/hr of ethylene and 42 kg/hr of octene. The temperature of this fresh feed to reactor 2 was 30° C. The total flow of feeds to R2 consisted of the fresh feed combined with the contents from R1. Total flow rates are shown as entry “TSR” in Table 1.

Table 1 also shows hydrogen flow rates (grams per hour, added as a telomerization agent to reduce polymer molecular weight) and catalyst concentrations. By way of illustration, the aim point for titanium concentration in reactor 1 for product 1 was 2.77 ppm (weight basis); the Mg/Ti ratio was 1.33 (where Al1 refers to moles Aluminum provided by the TEAL); the TBC/Mg mole ratio was 2.01 and the Al2/Ti ratio was 1.21 (where Al2 refers to moles aluminum provided by the DEAO).

The ΔTR1 and ATR2 entries in Table 1 are a measure of the internal temperature gradient within reactors R1 and R2 respectively. A pair of thermocouples is located in each of the reactors with one thermocouple being located in the top third of the reactor and the second being located in the bottom third. The temperature difference (or delta, or “Δ”) between these thermocouples is shown in Table 1. For example, ΔTR1 (the temperature difference between the two thermocouples in reactor 1) was 1.3° C. for product 1 and ΔTR2 was 6.3° C. for product 1. R1 was equipped with a dual sheer agitator system comprising a conventional (but efficient) agitator plus a helical ribbon (as disclosed in U.S. application Ser. No. 09/048,945 (now U.S. Pat. No. 6,024,483)) and R2 was equipped with a conventional agitator and a high powered motor to drive the agitator.

TABLE 1
Polymerization Conditions

| PRODUCT | 1 | 2 | 3 |
|---|---|---|---|
| R1 | | | |
| TSR (kg/hr) | 740 | 620 | 780 |
| Total Flow (kg/hr) | 360 | 300 | 340 |
| Ethylene (kg/hr) | 32 | 28 | 30 |
| Octene (kg/hr) | 21 | 20 | 20 |
| Hydrogen (g/hr) | 0.6 | 0.5 | 0.3 |
| R1 Inlet (° C.) | 30 | 35 | 41 |
| R1 Outlet (° C.) | 137 | 144 | 143 |
| Δ TR1 | 1.3 | 0.5 | 1.1 |
| Reactor Pressure | 14.5 | 14.2 | 14.2 |
| (Mpa) | | | |
| QR1 (%) | 94 | 86 | 88 |
| R2 | | | |
| Total Flow (k/hr) | 380 | 320 | 440 |
| Ethylene (kg/hr) | 72 | 52 | 70 |
| Octene (kg/hr) | 42 | 35 | 38 |
| R2 Inlet (° C.) | 30 | 31 | 35 |
| R2 Outlet (° C.) | 187 | 185 | 184 |
| Δ TR2 | 6.3 | 7.3 | 6.8 |
| Reactor Pressure | 14.3 | 14.0 | 13.9 |
| (Mpa) | | | |
| QR2(%) | 85 | 90 | 88 |
| R1 Catalyst | | | |
| Ti (ppm) | 3.23 | 3.6 | 2.77 |
| Mg/Al1 | 1.42 | 1.42 | 1.33 |
| TBC/Mg | 1.97 | 1.90 | 2.01 |
| Al2/Ti | 1.63 | 1.35 | 1.48 |
| R2 Catalyst | | | |
| Ti (ppm) | 3.00 | 3.56 | 3.24 |
| Mg/Al1 | 1.43 | 1.70 | 1.12 |
| TBC/Mg | 1.97 | 2.25 | 2.25 |
| Al2/Ti | 1.45 | 1.32 | 1.21 |
| Density (g/cc) | 0.918 | 0.919 | 0.923 |
| I₂ | 0.8 | 0.63 | 0.41 |
| S.Eₓ | 1.39 | 1.44 | 1.41 |
| COHO | 5.5 | 5.2 | 4.8 |

TABLE 1A
Processing Conditions of Basic Resins - Macro Extrusion

| Processing Conditions | C1 | C2 | 1 | 2 | 3 |
|---|---|---|---|---|---|
| Melt Temperature (° F.) | 445 | 442 | 444 | 446 | 463 |
| Frost Line Height (in) | 7.5 | 7.5 | 7.5 | 7.25 | 7 |
| Die Gap (mil) | 35 | 35 | 35 | 35 | 35 |
| BUR | 2.5 | 2.5 | 2.5 | 2.5 | 2.5 |
| Film Gauge (mil) | 1 | 1 | 1 | 1 | 1 |
| Extruder Current (A) | 39 | 36 | 34 | 35 | 35 |
| Pressure (psi) | 3310 | 2815 | 3130 | 3295 | 3290 |
| Screw Speed (rpm) | 94.1 | 95.8 | 101.2 | 102.7 | 101.1 |
| Output (lbs/hr) | 40.1 | 39.8 | 39.9 | 39.7 | 39.1 |

TABLE 2A
Processing Conditions of Resin Blends- Macro Extrusion

| | 90% C2 & | 90% C1 & | 90% 1 & |
|---|---|---|---|
| Processing Conditions | 10% C4 | 10% C4 | 10% C4 |
| Melt Temperature (° F.) | 440 | 440 | 440 |
| Frost Line Height (in) | 7.25 | 6.75 | 7.25 |
| Die Gap (mil) | 35 | 35 | 35 |
| BUR | 2.5 | 2.5 | 2.5 |
| Film Gauge (mil) | 1 | 1 | 1 |
| Extruder Current (A) | 35 | 36.5 | 33 |
| Pressure (psi) | 2805 | 3175 | 3025 |
| Screw Speed (rpm) | 100.3 | 94 | 101.4 |
| Output (lbs/hr) | 39.7 | 39.4 | 39.5 |

TABLE 3A
Processing Conditions of Resin Blends- Gloucester Extrusion

| | | 95% 2 & | 90% C1 & | 90% C5 & |
|---|---|---|---|---|
| Processing Conditions | 2 | 5% C4 | 10% C4 | 10% C4 |
| Melt Temperature (° F.) | 434 | 446 | 439 | 448 |
| Frost Line Height (in) | 28 | 41 | 37 | 34 |
| Die Gap (mil) | 35 | 35 | 35 | 35 |
| BUR | 2.5 | 2.5 | 2.5 | 2.5 |
| Film Gauge (mil) | 2 | 2 | 2 | 2 |
| Extruder Current (A) | 57.5 | 55.5 | 57.1 | 67.1 |
| Pressure (psi) | 29.75 | 28.75 | 29.55 | 34.55 |
| Screw Speed (rpm) | 65 | 93 | 86 | 75 |
| Output (lbs/hr) | 154 | 205 | 206.2 | 182 |

Part 2

This illustrates the preparation of plastic films according to this invention.

Part 2.1 Monolayer Films

Films were prepared on two different monolayer blown film lines which are described below.

The first film line (“Macro line”) included A) a single screw extruder (with a standard compression screws having a 1.5″ diameter and a length/diameter (“UD”) ratio of 24:1, equipped with a mixing section having a configuration known to those skilled in the art as a “Maddock” mixer; and B) a 3″ diameter die having a dual lip air ring.

The second film line (“Gloucester line”) included A) a single screw extruder having a barrier screw (sold by Brampton Engineering under the tradename Brampton Barrier Screw) with a 2.5″ diameter and an UD of 24:1; and B) a 4″ diameter die equipped with a dual lip air ring.

The extrusion conditions used to prepare the samples are given in Tables 1 A, 2A and 3A.

Inventive resins 1, 2 and 3 were prepared in the manner described in Part A.

Comparative resins C1-C4 are commercially available resins having the following characteristics.

C1: an ethylene-octene resin having a density of 0.920 g/cc, a melt index, I₂, of 0.73 and a COHO ratio of 1.7.

C2: an ethylene-octene resin having a density of 0.921 g/cc, an I₂ of 0.97 and a COHO ratio of 3.7.

C3: an ethylene-hexene resin having a density of 0.926 g/cc, an I₂ of 0.80 and a COHO ratio of less than 3.

C4: a high pressure/low density ethylene homopolymer having a density of 0.920 g/cc and an I₂ of 0.75.

Film formulations and physical properties are shown in Table 2. The last three entries in Table 2 show blends with a high pressure/low density resin (“C4”). The blend formulations are expressed in weight %.

2.2 Multilayer Coextrusions

Blown film coextrusions were prepared using a three layer (“A,B,C”) “coex” line having the following features:

a) 3-1¾″ diameter extruders, 30:1 L/D ratio;

b) 3 general purpose screws each equipped with a “Maddock” mixer;

c) 4″ diameter die; and

d) isolated temperature control for each layer (see Table 3B).

The extrusion conditions are shown in Table 3A and Table 3B. Formulations are shown in Table 3C. Blends are weight %. By way of explanation: Trial 3 (Table 3C) shows a three layer resin made with resin C4 in the outer layer, inventive resin 1 in the core layer and C6 in the inner layer. The amounts of each resin were 15 weight % in the outer layer, 70 weight % in the core layer and 15 weight % in the inner layer.

Physical properties of the Coex films are shown in Table 3D. Inventive resin 1 was polymerized in a dual reactor polymerization process as described in Part 1.

Comparative resins C4 to C6 are commercially available polyethylene resins having the following characteristics:

C4: as described above in Part 2.1 above.

C5: a hexene copolymer having a density of 0.9245 g/cc and an I₂ of 0.79.

C6: a hexene copolymer having a density of 0.9357 g/cc and an I₂ of 0.54.

As shown in Table 3D, the films of this invention have an outstanding balance of “dart impact strength” and “tear” properties. As will be appreciated by those skilled in the art, films made with homogeneous (or “metallocene”) resins typically do not exhibit this balance of properties. Whilst not wishing to be bound by any theory, it is postulated that 1) the large “copolymer” fraction of the films is associated with the excellent dart impact strength (similar to “homogenous” films) and 2) the small, but essential, amount of homopolymer provides nucleating sites which serve to enhance the tear properties. Highly preferred COHO ratios are from 4 to 8.

Table 3C also includes data which illustrate the improved line running rates which may be achieved according to this invention. Control example 1 (Table 3C) was undertaken at a recommended/conventional line running rate of 120 lbs of polyethylene resin per hour. The running rate was gradually increased until unstable conditions were observed. The maximum line rate was 136 lbs/hr (Control experiment 2, Table 3C). The “core layer” plastic was then replaced with inventive resin 1 (leaving the outer layer and inner layer compositions constant). Trials 3 and 4 were then conducted as per trials 1 and 2, with a maximum line rate of 154 lbs per hour being achieved (Trial 4, Table 3C). This illustrates the substantial productivity enhancements (i.e. improved line speeds) which are achievable according to the present invention. Likewise, trial 5 shows that enhanced line speeds may be achieved even if the amount of inventive resin in the core layer is reduced (to 45 weight % of the total resin employed).

TABLE 2
Physical Properties of Monolayer Films For Basic Resins and Blends

| Film Line | Macro | Macro | Macro | Macro | Macro | Macro | Macro | Macro |
|---|---|---|---|---|---|---|---|---|
| Resin Physical Properties | C1 | C2 | 1 | 2 | 3 | C2 & 10% C4 | C1 & 10% C4 | 90% 1 & 10% C4 |
| Melt Strength (g/3 min) | 0.185 | 0.153 | 0.279 | 0.305 | 0.357 | | | |
| Dart Impact (g/mil) | 261 | 200 | 351 | 267 | 369 | 210 | 170 | 328 |
| Tear - MD (g/mil) | 438 | 368 | 337 | 445 | 501 | 164 | 207 | 155 |
| Tear - TD (g/mil) | 746 | 700 | 694 | 880 | 809 | 671 | 745 | 692 |
| Tensile Str @ Break MD (Mpa) | 45.5 | 42.5 | 45.8 | 49.9 | 70.9 | 42.5 | 44.5 | 47.9 |
| Tensile Str @ Break TD (Mpa) | 34.4 | 40.1 | 44.1 | 39.4 | 54.5 | 33.2 | 37.0 | 38.9 |
| Tensile Yield Strength - MD (Mpa) | 10.1 | 10.0 | 8.6 | 9.1 | 10 | 9.9 | 10.1 | 9.3 |
| Tensile Yield Strength - TD (Mpa) | 9.7 | 10.0 | 9.1 | 9.7 | 11.5 | 10.1 | 10.6 | 9.6 |
| Tensile Elongation MD (%) | 574 | 594 | 507 | 494 | 513 | 605 | 590 | 535 |
| Tensile Elongation TD (%) | 937 | 935 | 988 | 964 | 978 | 907 | 957 | 950 |
| Tensile Elongation @ Yield MD (%) | 11 | 11 | 9 | 9 | 7 | 12 | 10 | 9 |
| Tensile Elongation @ Yield TD (%) | 13 | 13 | 13 | 13 | 11 | 13 | 12 | 12 |
| Tensile Energy (J) MD | 1.99 | 1.69 | 1.68 | 1.65 | 2.39 | 2.04 | 2.02 | 1.91 |
| Tensile Energy (J) TD | 2.41 | 2.38 | 2.79 | 2.55 | 3.41 | 2.24 | 2.54 | 2.49 |
| 1% Secant Modulus MD (Mpa) | 176 | 174 | 163 | 177 | 212 | 176 | 188 | 176 |
| 1% Secant Modulus TD (Mpa) | 187 | 173 | 179 | 184 | 237 | 194 | 234 | 200 |
| 2% Secant Modulus MD (Mpa) | 149 | 148 | 146 | 151 | 185 | 153 | 158 | 150 |
| 2% Secant Modulus TD (Mpa) | 150 | 146 | 142 | 146 | 193 | 157 | 186 | 164 |
| Thickness (mil) | 1.01 | 0.98 | 1.01 | 0.98 | 1.12 | 0.97 | 0.96 | 0.98 |

Note:
MD = Machine direction
TD = Tear direction

TABLE 3A
Coex Extrusion Conditions

| Extruder A | | Extruder B | | Extruder C | |
|---|---|---|---|---|---|
| Standard | | Standard | | Standard | |
| Conditions | (F) | Conditions | (F) | Conditions | (F) |
| Barrel Zone 1 | 370 | Barrel Zone 1 | 370 | Barrel Zone 1 | 370 |
| Barrel Zone 2 | 390 | Barrel Zone 2 | 390 | Barrel Zone 2 | 390 |
| Barrel Zone 3 | 400 | Barrel Zone 3 | 400 | Barrel Zone 3 | 400 |
| Barrel Zone 4 | 400 | Barrel Zone 4 | 400 | Barrel Zone 4 | 400 |
| Screen Zone | 400 | Screen Zone | 400 | Screen Zone | 400 |
| Die | 400 | Die | 400 | Die | 400 |

TABLE 3B
Coex Die Extrusion Conditions
Die Body ° F.

| | |
|---|---|
| Bottom Mandrel | 400 |
| Mandrel | 400 |
| C Layer | 400 |
| B Layer | 400 |
| A Layer | 400 |

Notes:
Die gap 35 mil;
Blow up ratio = 2:1;
Frost line height = 18″;
Total film thickness = 23 mil

TABLE 3C
Composition of Coex Structures and Production Rate

| Trial | Outer | Core | Inner | Gauge | Rate |
|---|---|---|---|---|---|
| # | Layer | Layer | Layer | mil | (lb/hr) |
| 1 Control | 15% C4 | 70% C5 | 15% C6 | 2.95 | 120* |
| 2 Control | 15% C4 | 70% C5 | 15% C6 | 3.14 | 136* |
| 3 | 15% C4 | 70% 1 | 15% C6 | 2.98 | 120* |
| 4 | 15% C4 | 70% 1 | 15% C6 | 3.14 | 154* |
| 5 | 40% C1 | 45% 1 | 15% C6 | 3.1 | 141* |
| 6 | 40% C1 | 45% 1 | 15% C6 | 2.98 | 120* |
| 7 | 30% C1 | 45% 1 | 25% C6 | 3.08 | 120* |
| 8 | 30% C1 | 40% 1 | 30% C6 | 3.25 | 120* |
| 9 | 25% C1 | 40% 1 | 35% C6 | 3.2 | 120* |

* Maximum line rate.

TABLE 3D
Coex Films Physical Properties

| Structure # | 1 Control | 2 Control | 3 | 4 | 5 | 6 | 7 | 8 | 9 |
|---|---|---|---|---|---|---|---|---|---|
| Gauge mil | 2.95 | 3.14 | 2.98 | 3.14 | 3.1 | 2.98 | 3.08 | 3.25 | 3.2 |
| RATE (lb/hr) | 120 | 136 | 120 | 154 | 141 | 120 | 120 | 120 | 120 |
| F SECMOD 1 MD (ASTM-D882) | 205 | 217 | 178 | 186 | 188 | 181 | 199 | 211 | 214 |
| F SECMOD 1 TD (ASTM-D882) | 255 | 268 | 206 | 224 | 225 | 217 | 230 | 238 | 248 |
| F SECMOD 2 MD (ASTM-D882) | 167 | 174 | 149 | 155 | 154 | 150 | 162 | 170 | 174 |
| F SECMOD 2 TD (ASTM-D882) | 195 | 202 | 169 | 180 | 178 | 172 | 186 | 186 | 189 |
| DART (ASTM D 1709-85) | 125 | 122 | 192 | 173 | 188 | 197 | 163 | 154 | 142 |
| FILM TEAR MD (ASTM D1922) | 274 | 274 | 299 | 283 | 381 | 356 | 354 | 340 | 351 |
| FILM TEAR TD | 539 | 548 | 549 | 580 | 554 | 568 | 550 | 548 | 545 |
| FTEN BRK MD (ASTM D-638-89) | 34.6 | 33.1 | 42.5 | 38.3 | 49 | 48.3 | 46.7 | 42.4 | 44.1 |
| FTEN BRK TD (ASTM D-638-89) | 34.8 | 36 | 43.2 | 43.3 | 49 | 48.1 | 43 | 43.3 | 41.3 |
| FTEN ELG MD (ASTM D-638-89) | 669 | 662 | 649 | 612 | 669 | 669 | 664 | 668 | 673 |
| FTEN ELG TD (ASTM D-638-89) | 742 | 779 | 757 | 787 | 783 | 772 | 739 | 767 | 742 |
| FTEN ENGY MD (ASTM D-638-89) | 2.75 | 2.69 | 2.74 | 2.52 | 3.12 | 3.03 | 2.96 | 3.02 | 2.88 |
| FTEN ENGY TD (ASTM D-638-89) | 2.95 | 3.15 | 3.01 | 5.6 | 3.48 | 3.36 | 3.11 | 3.36 | 3.14 |
| FTEN YD MD (ASTM D-638-89) | 11.3 | 11.1 | 9.8 | 10 | 9.9 | 9.7 | 10.4 | 10 | 11.6 |
| FTEN YD TD (ASTM D-638-89) | 13 | 12.7 | 11.3 | 11.4 | 11.3 | 11.1 | 11.3 | 11.4 | 12.3 |
| FTEN YDELG MD (ASTM D-638-89) | 10 | 10 | 9 | 7 | 9 | 8 | 7 | 8 | 16 |
| FTEN YDELG TD (ASTM D-638-89) | 10 | 13 | 13 | 11 | 14 | 12 | 7 | 12 | 12 |

Notes:
SEC MOD = Secant Modulus
TEN = Tensile
BRK = Break
ELG = Elongation
ENG = Energy

What is claimed is:

1. Polyethylene film having a melt strength of greater that 0.20 grams per three minutes and a dart impact strength of greater that 200 grams per ml as determined by ASTM D1708-85,
wherein said polyethylene film is prepared from a linear low density polyethylene characterized by having:
i) a melt index as determined by ASTM of from 0.4 to 1.5;
ii) a polydispersity, Mw/Mn, of from 3.5 to 7;
iii) a copolymer/homopolymer ratio of from 3 to 19; and
iv) a density of from 0.915 to 0.930 grams per cubic centimeter,
and wherein said polyethylene resin is prepared in a dual reactor polymerization process.

2. The polyethylene film of claim 1 wherein said dual reactor polymerization process is a solution polymerization process.

3. The polyethylene film of claim 2 wherein said solution polymerization process is characterized by the combination of:
A) the use of a Ziegler-Natta catalyst system; and
B) the use of at least two intensively mixed polymerization reactors which are arranged in series.

4. The polyethylene film of claim 3 wherein each of said polymerization reactors is characterized by having an internal temperature gradient of less than 10° C.

5. The polyethylene film of claim 3 wherein said Ziegler Natta catalyst system must contain titanium tetrachloride, a magnesium alkyl, an aluminum alkoxide and a halogenation agent as essential ingredients.

6. The polyethylene film of claim 5 wherein said aluminum alkoxide is diethyl aluminum ethoxide.

7. The polyethylene film of claim 6 wherein said halogenation agent is tertiary butyl chloride.

8. The polyethylene film of claim 3 wherein said copolymer/homopolymer ratio is from 4 to 8.

9. The polyethylene film of claim 1 wherein said linear low density polyethylene resin is a copolymer of ethylene and octene.
